(19) United States
(12) Patent Application Publication
(10) Pub. No.: US 2025/0261063 A1
(43) Pub. Date: Aug. 14, 2025

(54) METHOD AND APPARATUS FOR OPTIMIZING CELL HANDOVER PERFORMANCE IN WIRELESS COMMUNICATION SYSTEM

(71) Applicant: Samsung Electronics Co., Ltd., Gyeonggi-do (KR)

(72) Inventors: Yu PAN, Beijing (CN); Lixiang XU, Beijing (CN); Hong WANG, Beijing (CN); Weiwei WANG, Beijing (CN)

(21) Appl. No.: 19/048,109

(22) Filed: Feb. 7, 2025

(30) Foreign Application Priority Data
Feb. 8, 2024 (CN) 202410177948.8

(51) Int. Cl. H04W 36/08; H04W 36/00

(52) U.S. Cl. CPC H04W 36/08; H04W 36/0061

(57) ABSTRACT

The disclosure relates to a fifth generation (5G) or sixth generation (6G) communication system for supporting a higher data transmission rate. A method performed by a first node in a communication system includes receiving a first message from a second node, the first message including at least one of first configuration information or second configuration information, and transmitting a second message to a user equipment (UE), the second message including third configuration information being determined based on at least one of the first configuration information or the second configuration information.

### CROSS-REFERENCE TO RELATED APPLICATION(S)

This application is based on and claims priority under 35 U.S.C. § 119 to Chinese Patent Application No. 202410177948.8, which was filed in the China National Intellectual Property Administration on Feb. 8, 2024, the disclosure of which is incorporated herein by reference in its entirety.

### BACKGROUND

### 1. Field

The disclosure relates to the field of communication, and more particularly, to an enhanced configuration method for improving cell handover performance in a wireless communication system.

### 2. Description of Related Art

To meet an increasing demand for wireless data communication services since the deployment of the fourth generation (4G) communication system, efforts have been made to develop an improved fifth generation (5G) or pre-5G communication system, referred to as a beyond 4G network or post long term evolution (LTE) system.

5G mobile communication technologies define broad frequency bands such that high transmission rates and new services are possible, and can be implemented not only in sub 6 gigahertz (GHz) bands such as 3.5 GHz, but also in above 6GHz bands referred to as millimeter wave (mmwave) bands including 28 GHz and 39 GHz bands. In addition, it has been considered to implement 6G mobile communication technologies (referred to as beyond 5G systems) in terahertz bands (e.g., 95 GHz to 3 THz bands) to accomplish transmission rates fifty times faster than 5G mobile communication technologies and ultra-low latencies one-tenth of 5G mobile communication technologies.

Since the beginning of the development of 5G mobile communication technologies, to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmwave, supporting numerologies (e.g., operating multiple subcarrier spacings) for efficiently utilizing mm Wave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed

(NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial Internet of things (IIoT) for supporting new services through interworking and convergence with other industries, integrated access and backhaul IAB) for providing a node for network service area expansion by supporting a wireless backhaul link and an access link in an integrated manner, mobility enhancement including conditional handover and dual active protocol stack (DAPS) handover, and two-step random access channel for NR (2-step RACH for NR) to simplify random access procedures. There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Such development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

In NR, the dual connectivity (DC) is introduced to improve the network performance and single-user traffic, and the performance of this technology is also constantly improved. In dual connection, the UE will connect with two nodes, one as the master node (MN) and the other as the secondary node (SN), which may also be referred to as an S-NODE. Among them, a group of cells serving the UE in the MN is referred to as a master cell group (MCG), and a group of cells serving UE in the SN is referred to as a SCG (SCG). The MCG is referred to as a primary cell (PCell), and the SCG is referred to as a primary SCG cell (PSCell). The cell group is abbreviated by CG.

The handover of UE cells can adopt a conditional reconfiguration mode, that is, the network provides multiple candidate cells and the execution condition to the UE, and the UE evaluates the execution condition and selects the target cell from the cells that meet the execution condition. Conditional handover (CHO), conditional PSCell addition, conditional PSCell change (CPC) and subsequent conditional PSCell addition or change (CPAC) all belong to conditional reconfiguration. CPA and CPC can be collectively referred to as CPAC. Subsequent CPAC (S-CPAC) can be used for PSCell change in intra-SN, that is, Intra-SN subsequent CPAC (Intra-SN S-CPAC, that is, S-CPAC in SN). Cell change can also be referred to as cell handover, and cell handover/change can be PCell handover/change or PSCell handover/change.

To improve the performance of cell handover, an enhanced configuration method is needed in the art.

Furthermore, the number of wireless communication services subscribers has exceeded 5 billion, and that number continues to increase. Given the enormous popularity of smart phones and other mobile data devices (such as tablet computers, notebook computers, netbooks, e-book readers and machine-type devices) in consumers and enterprises, there is a need in the art for improved efficiency and coverage of wireless interfaces to meet rapid growth of mobile data services and support new applications and deployments.

### SUMMARY

The disclosure has been made to address at least the above-mentioned problems and/or disadvantages and to provide at least the advantages described below.

Accordingly, an aspect of the disclosure is to provide an enhanced configuration method for improving cell handover performance in a wireless communication system.

In accordance with an aspect of the disclosure, a method performed by a first node in a communication system includes receiving a first message from a second node, the first message including at least one of first configuration information or second configuration information, and transmitting a second message to a user equipment (UE), the second message including third configuration information being determined based on at least one of the first configuration information or the second configuration information.

In accordance with an aspect of the disclosure, a method performed by a user equipment (UE) in a communication system includes receiving a second message from a first node, the second message including third configuration information being determined based on at least one of first configuration information or second configuration information included in a first message transmitted by a second node to the first node, and performing a subsequent conditional physical cell addition or change (S-CPAC), based on the third configuration information.

In accordance with an aspect of the disclosure, a method performed by a second node in a communication system Includes transmitting a first message to a first node, the first message including at least one of first configuration information, second configuration information, or a measurement result, and receiving a third message from the first node, the third message including information of one or more candidate cells, wherein the information of one or more candidate cells included in the third message is determined based on the first configuration information or the measurement result and causes a number of candidate cells configured by the second node for conditional reconfiguration to be less than or equal to a user equipment capability.

In accordance with an aspect of the disclosure, a UE includes a transceiver configured to transmit and receive signals, and a controller configured to control the transceiver to perform a method in a communication system, the method comprising receiving a second message from a first node, the second message including third configuration information being determined based on at least one of first configuration information or second configuration information included in a first message transmitted by a second node to the first node, and performing a subsequent conditional physical cell addition or change (S-CPAC), based on the third configuration information.

In accordance with an aspect of the disclosure, a first node device includes a transceiver configured to transmit and receive signals, and a controller configured to control the transceiver to perform a method in a communication system, the method comprising receiving a first message from a second node device, the first message including at least one of first configuration information or second configuration information, and transmitting a second message to a user equipment (UE), the second message including third configuration information being determined based on at least one of the first configuration information or the second configuration information.

### BRIEF DESCRIPTION OF THE DRAWINGS

The above and other aspects, features, and advantages of certain embodiments of the disclosure will be more apparent from the following detailed description taken in conjunction with the accompanying drawings, in which:

FIG. 1 illustrates a system architecture of a system architecture evolution (SAE) according to an embodiment;

FIG. 2 illustrates a system architecture according to an embodiment;

FIG. 3 illustrates an interaction among a user equipment, a first node and a second node according to an embodiment;

FIG. 4 illustrates an interaction among a user equipment, a first node and a second node according to an embodiment;

FIG. 5 illustrates an interaction among a user equipment, a first node and a second node according to an embodiment;

FIG. 6 illustrates an interaction among a user equipment, a first node and a second node according to an embodiment;

FIG. 7 illustrates the structure of a user equipment according to an embodiment;

FIG. 8 illustrates the structure of a first node according to an embodiment; and

FIG. 9 illustrates the structure of a second node according to an embodiment.

### DETAILED DESCRIPTION

The following description with reference to the accompanying drawings is provided to assist in a comprehensive understanding of various embodiments of the present disclosure. The description includes various specific details to assist in that understanding but should be regarded as examples only. Accordingly, the ordinary skilled in the art will recognize that various changes and modifications to the various embodiments described herein can be made without departing from the scope and spirit of the present disclosure. Descriptions of well-known functions and structures may be omitted for the sake of clarity and conciseness.

Elements expressed in the singular form may also be understood to be expressed in the plural form. Similar words such as singular forms “a”, “an” or “the” do not express a limitation of quantity, but express the existence of at least one of the referenced item, unless the context clearly dictates otherwise. For example, reference to “a component surface” includes reference to one or more of such surfaces.

The terms and wordings used in the following description and claims are not limited to the bibliographical meanings, but are merely used by the inventor to enable a clear and consistent understanding of the present disclosure. Accordingly, it should be apparent to those skilled in the art that the following description is provided for illustration purposes only, and not for the purpose of limiting the present disclosure.

The singular forms “a,” “an,” and “the” include plural referents, unless clearly indicated otherwise in the context. Thus, for example, reference to “a component surface” includes reference to one or more of such surfaces.

The term “include” or “may include” refers to the existence of a corresponding disclosed function, operation or component which can be used in various embodiments of the present disclosure, and does not limit the existence of one or more additional functions, operations, or components. The terms “include” and/or “have” may be construed to represent certain characteristics, numbers, steps, operations, constituent elements, components or combinations thereof, but may not be construed to exclude the possibility of existence of one or more other characteristics, numbers, steps, operations, constituent elements, components or combinations thereof.

The term “or” used herein includes any of the listed terms or all combinations thereof. For example, “A or B” may include A, may include B, or may include both A and B.

Unless defined differently, all terms used in the present disclosure, including technical or scientific terms, have the same meanings as those understood by the skilled in the art as described herein. Common terms as defined in a dictionary are to be interpreted to have meanings consistent with the context in the relevant technical field o, and are not to be interpreted ideally or excessively, unless clearly defined as such in the present disclosure.

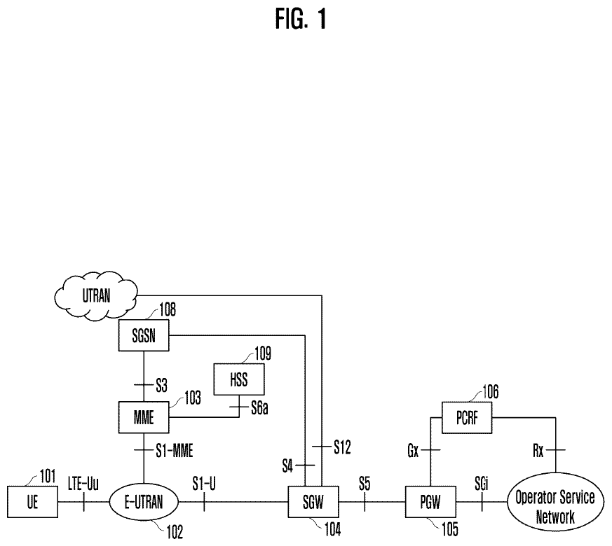

FIG. 1 illustrates a system architecture 100 of SAE according to an embodiment. Referring to FIG. 1, the UE 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides user plane, and the MME 103 and the SGW 104 may be in the same physical entity. A packet data network gateway (PGW) 105 is responsible for charging, lawful interception, etc., and may be in the same physical entity as the SGW 104. A policy and charging rules function entity (PCRF) 106 provides quality of service (QOS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, etc.

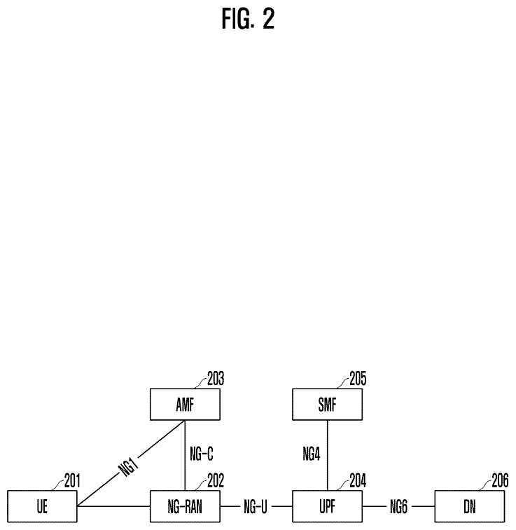

FIG. 2 illustrates a system architecture 200 according to an embodiment. Other embodiments of the system architecture 200 can be used without departing from the scope of the present disclosure.

The UE 201 is a terminal device for receiving data. A next generation radio access network (NG-RAN) 202 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides user plane functions. A session management function entity SMF 205 is responsible for session management. A data network (DN) 206 includes, for example, services of operators, access of Internet and service of third parties.

Herein, a node may be a complete base station, a base station including a centralized unit and a distributed unit, or a base station including a central unit control plane, CU-CP), a central unit-user plane (CU-UP) and a distributed unit.

However, the message name is just an example, and messages can have other names. The sequence number of messages does not represent the order of message execution, but only the name of the message.

Disclosed is a method performed by a first node in a communication system, including receiving a first message from a second node, wherein the first message includes first configuration information and/or second configuration information, and transmitting a second message to the user equipment UE, wherein the second message includes third configuration information, and wherein the third configuration information is determined based on the first configuration information and/or the second configuration information.

In the above method, the first node (for example, the MN node) determines the third configuration information based on the first configuration information and/or the second configuration information transmitted by the second node (for example, the SN node), which is beneficial to realize the flexibility of reconfiguration information transmission and improve the cell handover performance.

The following occurs in the configuration method for cell handover.

When SN determines to trigger Intra-SN S-CPAC:

In step 1, the SN completes the selection of candidate cells for S-CPAC, cell group configuration of the candidate cells, and configuration of initial S-CPAC execution condition and following (or next) Subsequent CPAC/S-CPAC execution condition. Specifically:

The SN selects a candidate cell (candidate PSCell) for UE in SN for S-CPAC. Alternatively, the selection of the candidate cell may be based on the measurement result or other information.

The SN determines (or configures) the S-CPAC execution condition for the selected candidate cell for initial S-CPAC. That is, by evaluating the candidate cell, when one or more candidate cells meet the execution condition, the UE selects a candidate cell as the target cell, handovers from the source cell (source PSCell) to the target cell (target PSCell), and performs the S-CPAC. The S-CPAC execution process can be referred to as the initial S-CPAC execution process. The execution conditions are provided by the source PSCell (or SN).

The SN allocates resources for the UE on the candidate PSCell (that is, performs resource configuration), and selects a corresponding candidate cell (e.g., candidate cell 2, candidate cell 3, etc.) for the candidate PSCell (e.g., candidate cell 1) for following S-CPAC. That is, when the candidate cell (e.g., candidate cell 1) serves as the target cell, the corresponding candidate cell (e.g., candidate cell 2, candidate cell 3, etc.) will serve as the candidate cell of the candidate cell (e.g., candidate cell 1) for following S-CPAC.

The SN determines the S-CPAC execution conditions for the corresponding candidate cells for the following S-CPAC.

In step 2, the SN provides information for S-CPAC to MN including the following:

The information for the S-CPAC determined in step 1 is provided to the MN, including the candidate cell identification for the S-CPAC, the cell group configuration of the candidate cell, the initial S-CPAC execution condition information, and the candidate cell identifications and execution condition information for the following S-CPAC, etc.

If the information for S-CPAC is transmitted to the UE through the MN, the SN will select a configuration format and instruct the MN to send the information for S-CPAC to the UE through the configuration format.

In step 3, the MN receives information from the SN, which contains information for conditional reconfiguration (for example, information for S-CPAC). If MN needs to send information to UE in MN format (also called MN configuration format or a first format) for S-CPAC based on the indication of SN, then:

The MN generates information in the MN format based on the received information for conditional reconfiguration (e.g., S-CPAC) and sends it to the UE, that is, the MN sends the received information for conditional reconfiguration to the UE in the MN format. The MN format is the information format used by the information for conditional reconfiguration transmitted by the MN to the UE. The information for conditional reconfiguration transmitted by the MN to the UE will be included in the conditional reconfiguration information element and the multi-radio DC SCG configuration information element.

The conditional reconfiguration information element contains one or more conditional reconfiguration information, and each conditional reconfiguration information corresponds to a candidate cell, that is, the conditional reconfiguration information contains conditional reconfiguration information (or configuration information) related to the corresponding candidate cell. Therefore, the conditional reconfiguration information element contains configuration information related to one or more candidate cells, which can also be said to include configuration information of one or more candidate cells.

The conditional reconfiguration information includes information such as a conditional reconfiguration identification, conditional radio resource control (RRC) reconfiguration information, execution condition information, and subsequent conditional reconfiguration information.

The conditional reconfiguration identification corresponds to the candidate cell,

The conditional RRC reconfiguration information contains the cell group configuration information of the candidate cell.

The subsequent conditional reconfiguration information is used for subsequent conditional reconfiguration, e.g. for S-CPAC.

To support the subsequent conditional reconfiguration, such as S-CPAC, the SN configures (or selects) the corresponding candidate cells for the candidate cell, and determines (or configures) the execution conditions. For example, the candidate cell is Cell1, and its corresponding candidate cells are Cell2 and Cell3. Then when Cell1 is the target cell, Cell2 and Cell3 will be used as candidate cells for subsequent cell changes. The candidate cells and execution condition information corresponding to the candidate cell are sent to the MN, and the MN includes the candidate cells and execution condition information corresponding to the candidate cell in the subsequent conditional reconfiguration information and sends it to the UE. The subsequent conditional reconfiguration information includes a conditional reconfiguration identification corresponding to (associated with) the corresponding candidate cell, and execution condition information. When the corresponding candidate cell meets the execution condition, the UE can select the candidate cell as the target cell and perform the subsequent conditional reconfiguration.

In the following S-CPAC, if all candidate cells are regarded as a set, which is referred to as a candidate cell set, then the corresponding candidate cells configured for each candidate cell also belong to the candidate cell set. MN assigns a corresponding conditional reconfiguration identification to each conditional reconfiguration information. Therefore, the UE can determine the cell group configuration information of the corresponding candidate cell through the conditional reconfiguration identification.

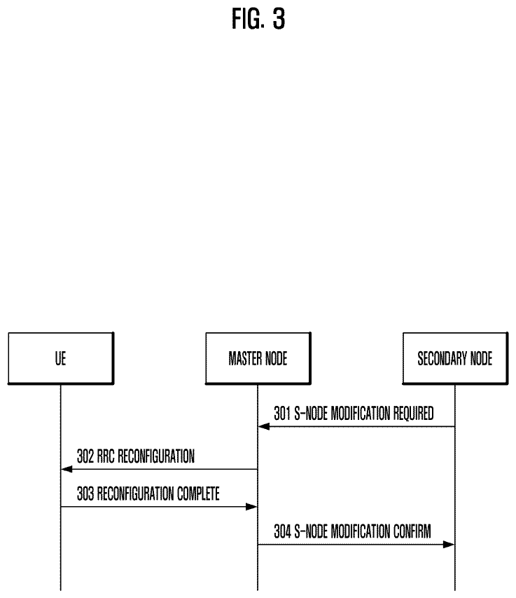

FIG. 3 illustrates an interaction among a user equipment, a first node and a second node according to an embodiment.

Referring to FIG. 3, in step 301, the SN sends a message to the MN. The message may be an S-NODE MODIFICATION REQUIRED message, or other messages. For example, when the SN uses the Intra-SN S-CPAC mechanism to change the PSCell, the information for Intra-SN S-CPAC is provided to the MN through the message. The information used for the Intra-SN S-CPAC can be sent to the UE through the MN, and the SN selects the format in which the information is transmitted to the UE through the MN, which can be the MN configuration format or the SN configuration format. The message (also called the first message, or other message names, the invention is not limited to this) contains at least one of the following pieces of information:

Identification information of the UE, which includes the identification of the UE on the master base station (M-NG-RAN node UE XnAP ID) and the identification of the UE on the secondary base station (S-NG-RAN node UE XnAP ID).

Configuration format indication (also called configuration format indication information, or other message names, the present invention is not limited to this), which indicates the information format used by the MN when transmitting information for S-CPAC to the UE. The configuration format may be an MN configuration format or a SN configuration format. The configuration format is selected by SN. The configuration format is indicated as optional.

The container from the first secondary node to the master node (also called the first container from the second node to the first node, or the first container, etc.). The container from the first secondary node to the master node may be a CG-CandidateList message, including configuration information of one or more candidate cells (also called first configuration information). The candidate cell and the configuration information of the candidate cell are used for S-CPAC. Wherein the configuration information of the candidate cell includes at least one of the following pieces of information:

SSB frequency information, that is, absolute radio frequency channel number (ARFCN) of a synchronization signal block (SSB) of the candidate cell.

An identification of the candidate cell (also called the identification of the first candidate cell), that is, the identification of the candidate (PSCell), which can be a physical cell identifier (PCI) or other cell identification. The candidate cell identification may also include the source PSCell identification.

Cell group configuration, or cell group configuration information, that is, cell group configuration (SCG-CellGroupConfig) of the SCG (or of the first candidate cell), which is the cell group configuration of SCG of the PSCell. The cell group configuration of the SCG of the candidate cell can also be referred to as cell group configuration information of the SCG of the candidate cell, or cell group configuration of the candidate cell, or cell group configuration information of the candidate cell, and so on. The cell group configuration may include SCG information or configuration information of candidate cells, for example, it may include at least one of the following pieces of information:

An SCG (secondaryCellGroup), or the second cell group, which contains the cell group configuration. The SCG is the cell group configuration or cell group configuration information of the PSCell.

Measurement configuration (measConfig), which can also be referred to as measurement configuration information. The measurement configuration is a measurement configuration provided by a PSCell (or SN).

A candidate cell information list (which can also be referred to as the fourth configuration information), a candidate cell information list for the following Subsequent CPAC process (candidateCellInfoListSubsequentCPC). When the first candidate cell is the target cell, the cell in the candidate cell information list is used as the candidate cell for the following S-CPAC process. The candidate cell information includes at least one of the following pieces of information:

A candidate cell identification (also called the third candidate cell identification), that is, the identification of the candidate PSCell, which can be PCI or other cell identifications.

Execution condition information (also called third execution condition information), that is, the execution condition associated to the candidate cell. When the candidate cell meets the execution condition, the UE can select the candidate cell as the target cell. The execution condition information is configured by SN or (the first candidate cell) for the execution of the following (or next) S-CPAC process.

Herein, the third candidate cell is a candidate cell selected (configured) by SN for the first candidate cell. When the first candidate cell is the target cell, the third candidate cell and the third execution condition information are used in the following S-CPAC process.

Herein, the cell group configuration and the candidate cell information list can be contained in one information element. The information element may be a cell group configuration information element (CG-Config IE).

A container from the second secondary node to the master node (also called the second container from the second node to the first node, or the second container, etc.). The container from the second secondary node to the master node may be a CG-Config message (also called second configuration information), which is SCG radio configuration information provided by SN, and contains execution condition information and/or configuration related information of one or more candidate cells. The candidate cell, the execution condition and the configuration are used for S-CPAC. The configuration information includes at least one of the following pieces of information:

Execution condition information of one or more candidate cells, which contains at least one of the following pieces of information:

A candidate cell identification (also called the identification of the fourth candidate cell), that is, the identification of the candidate PSCell, which can be PCI or other cell identifications. The candidate cell identification may be the first candidate cell identification.

Execution condition information (also called first execution condition information), which can also be referred to as execution condition or a conditional execution condition (condExecutionCond). The execution condition is an execution condition associated with the candidate cell. When the candidate cell meets the execution condition, the UE can select the candidate cell as the target cell. The execution condition information is configured by the source cell (PSCell) (or SN) and used for the initial S-CPAC process. The execution condition information can be identified by using the execution condition of the SCG condition (condExecutionCondSCG).

Cell group configuration, which can also be referred to as cell group configuration information or the cell group configuration of the SCG (SCG-CellGroupConfig), contains the cell group configuration information of the SCG of the source PSCell. It contains the measurement configuration (MeasConfig) related to the execution condition, which can also be referred to as measurement configuration information related to the first execution condition. The measurement configuration is a measurement configuration provided by a source PSCell (or SN).

A measurement result, which are included in the SN candidate cell information list (candidateCellInfoListSN), and which include the measurement result of the candidate cell and the measurement results of other cells.

Configuration information of one or more candidate cells, the candidate cells and the configuration information of the candidate cells are used for S-CPAC. The configuration information of the candidate cell may include at least one of the following:

Identification of the second candidate cell;

Cell group configuration of the second candidate cell;

Fifth configuration information, which is related to the following S-CPAC.

Herein, the specific description of the identification of the second candidate cell, the cell group configuration of the second candidate cell, and the fifth configuration information can refer to the specific description of the identification of the first candidate cell, the cell group configuration of the first candidate cell, and the fourth configuration information in the container from the first secondary node to the master node, and will not be described here again.

The following methods can be used to instruct the MN to send information for S-CPAC to the UE in MN format:

If the first message contains a container from the first secondary node to the master node, it means that the MN format is used.

If the first message contains a configuration format indication, indicating that the MN uses the MN format configuration, it means that the MN format is used.

In step 302, the MN sends a message to the UE (it can also be referred to as the second message, or other message names, but the present invention is not limited to this). The message may be an RRC reconfiguration message, or other messages. The message contains information provided to the UE, which is used for conditional reconfiguration (the information can be referred to as the third configuration information), for example, the information can be used for Intra-SN S-CPAC. Based on the information in step 301, the MN determines that the information for conditional reconfiguration needs to be provided to the UE in MN format, and then the MN will send the information for S-CPAC to the UE in the following information format based on the information (first configuration information and/or second configuration information) received in step 301. The configuration information (also called the third configuration information) includes at least one of the following pieces of information:

A Conditional Reconfiguration information element, which contains one or more conditional reconfiguration information. Each conditional reconfiguration information corresponds to the candidate cell, that is, the conditional reconfiguration information contains the conditional reconfiguration information (or configuration information) related to the corresponding candidate cell. Therefore, the conditional reconfiguration information element contains the configuration information of one or more candidate cells. The conditional reconfiguration information includes at least one of the following pieces of information:

A Conditional Reconfiguration identification (CondReconfigId) (which can also be referred to as the first conditional reconfiguration ID) for identifying the conditional reconfiguration information. The conditional reconfiguration identification corresponds to the candidate cell and is used for identifying the conditional reconfiguration information related to the candidate cell. The candidate cell related conditional reconfiguration information includes conditional RRC reconfiguration and execution conditions and/or subsequent conditional reconfiguration. The candidate cell is the candidate cell in the first configuration information and/or the second configuration information, so the conditional reconfiguration identification corresponds to the candidate cell in the first configuration information and/or the second configuration information.

Conditional RRC reconfiguration information, which contains cell group configuration information of candidate cells (or called cell group configuration of candidate cells. The measurement configuration information (or measurement configuration) of the candidate cell is included. The measurement configuration is provided by SN. The conditional RRC reconfiguration includes the cell group configuration of the candidate cell in the first configuration information and/or the second configuration information.

Execution condition information (also called second execution condition information) or execution condition information. When the candidate cell meets the execution condition, the UE can select the candidate cell as the target cell. If the candidate cell is a candidate cell corresponding to the source cell, the execution condition is used for initial S-CPAC. The execution condition includes the execution condition in the second configuration information.

Subsequent conditional reconfiguration (subsequentCondReconfig) information for the next S-CPAC process. The subsequent conditional reconfiguration information includes at least one of the following pieces of information:

A conditional reconfiguration identification (also called a second conditional reconfiguration identification), which corresponds to the candidate cell for the following S-CPAC. Each candidate cell has a conditional reconfiguration identification, so the candidate cell for the following S-CPAC also has a corresponding reconfiguration identification. The candidate cell is the candidate cell in the fourth or fifth configuration information. Therefore, the conditional reconfiguration identification corresponds to the candidate cell in the fourth or fifth configuration information.

Execution condition information (also referred to as fourth execution condition information or execution condition, and is used for the execution condition or execution condition information of the following S-CPAC process. The measurement configuration information related to the execution condition information is included in the conditional RRC reconfiguration information. The execution condition includes the execution conditions in the fourth configuration information or the fifth configuration information.

Multi-radio DC SCG configuration (mrdc-SecondaryCellGroup) information element, which contains the SCG information or configuration information (SCG information or SCG configuration information). The SCG information includes measurement configuration information related to the execution condition (which can also be referred to as measurement configuration information related to the second execution condition). The MN includes the cell group configuration information in the second configuration information received in step 301 as SCG information in the (mrdc-SecondaryCellGroup) information element. The measurement configuration information related to the execution condition contained therein is used for the execution of the initial S-CPAC process.

In step 303, the UE sends a message to the MN to indicate the completion of RRC reconfiguration. The message may be an RRCReconfiguration message, or other messages.

After receiving the message in step 302, the UE saves the information contained in the message, evaluates the candidate cell to determine whether the execution condition is met.

In step 304, the MN sends a message to SN. The message may be an S-NODE MODIFICATION CONFIRM message or other messages. MN indicates to SN that UE completes S-CPAC configuration.

By the method, the flexibility of conditional reconfiguration information transmission can be realized, and the cell handover performance can be improved.

In the method of FIG. 3, if SN chooses to send conditional reconfiguration information in MN format, for example, to send conditional reconfiguration information for Intra-SN S-CPAC, the SN needs to provide corresponding information to MN, for example, the information contained in the container from the first secondary node to the master node and the container from the second secondary node to the master node, for MN to provide S-CPAC information to send to UE in MN format. Therefore, when MN receives the information transmitted by the SN, if the MN also wants to trigger conditional reconfiguration to change the PCell or PSCell, to prevent the number of conditional reconfigurations configured by the SN and MN or the number of candidate cells for conditional reconfiguration from exceeding the maximum limit (or threshold), the MN can optionally adjust the number of conditional reconfigurations triggered by itself or adjust (reduce) the number of conditional reconfigurations provided by SN, for example, reducing the number of candidate cells. If the MN determines to reduce the number of candidate cells provided by SN, it can provide with the SN recommended candidate cells or provide a configurable number of candidate cells by the SN. Herein, the maximum value can be related to the UE capability, that is, the maximum value is set according to the UE capability to avoid exceeding the UE capability, for example, the UE can support a capability that the maximum number of conditional reconfiguration can support the maximum number of candidate cells for conditional reconfiguration. The SN provides updated information for S-CPAC according to the candidate cell recommended by The MN.

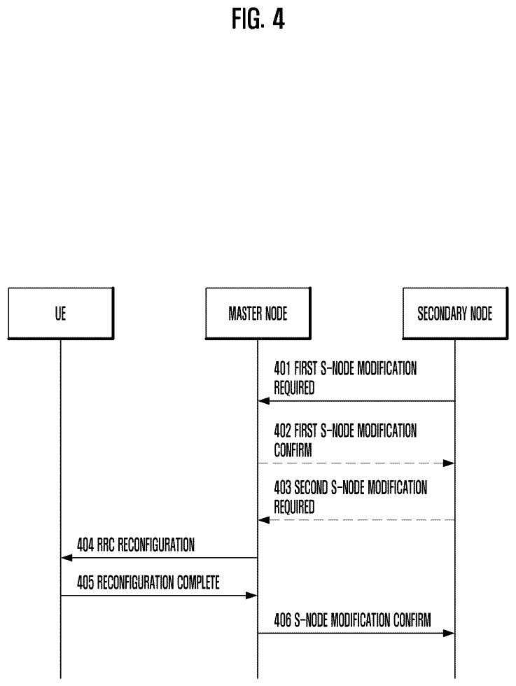

FIG. 4 illustrates an interaction among a user equipment, a first node and a second node according to an embodiment.

Referring to FIG, 4, in step 401, the SN sends a message to the MN, which may be an S-NODE MODIFICATION REQUIRED message or other messages. For example, when the SN uses the Intra-SN S-CPAC mechanism to change the PSCell, the information for Intra-SN S-CPAC is provided to the MN through the message. The information used for the Intra-SN S-CPAC can be sent to the UE through the MN, and the SN selects the format in which the information is transmitted to the UE through the MN, which can be sent in the MN format or in the SN format. For details of the message, please refer to step 301, which will not be described here.

If the MN determines to reduce the number of candidate cells provided by SN, steps 402 and 403 will be executed.

In step 402, the MN sends a message to the SN. The message may be an S-NODE MODIFICATION CONFIRM message or other messages. The message may also be referred to as the first secondary node modification confirmation message. The message contains at least one of the following pieces of information:

Information of one or more candidate cells. The candidate cell is used for S-CPAC. Herein the information of the candidate cell includes at least one of the following pieces of information:

SSB frequency information, that is, ARFCN of SSB of the candidate cell.

A candidate cell identification, which can use PCI or other cell identification. The candidate cell identification may be an identification of a candidate PSCell.

A maximum number of PSCells to prepare, indicating the maximum number of candidate cells that SN can configure.

Herein the information of one or more candidate cells and/or the maximum number of PSCells to prepare included in the third message are determined based on the first configuration information transmitted by the MN to the SN, so as to ensure that the number of candidate cells configured by the second node (for example, the SN) for conditional reconfiguration does not exceed the UE capability.

Step 403: SN sends a message (also called the fourth message, or other message names) to MN, which may be an S-NODE MODIFICATION REQUIRED message or other messages. The message may also be referred to as a second secondary node modification request. SN adjusts candidate cells according to the candidate cells recommended by MN or the maximum number of PSCells to prepare provided by MN, and provides updated information for S-CPAC. The message may include the updated first configuration information and/or the updated second configuration information. For details, please refer to the detailed description of the first configuration information and/or the second configuration information in step 301, which is not repeated here.

Steps 404-406 are the same as steps 302-304. See steps 302-304 for a detailed description, which will not be repeated here.

By the method, the flexibility of conditional reconfiguration information transmission can be realized, and at the same time, the number of conditional reconfiguration/the number of candidate cells for conditional reconfiguration can be prevented from exceeding the UE capability, which is beneficial to ensuring the reasonable application of conditional reconfiguration and improving the cell handover performance.

Embodiment 3 provides a configuration method for cell handover.

When SN determines to trigger Intra-SN S-CPAC, it sends the selected candidate cell identification list and the measurement result to MN. According to the received candidate cell identification provided by SN, if MN also wants to trigger the configuration of conditional reconfiguration at this time to change the PCell or PSCell, to prevent the number of conditional reconfigurations or the number of candidate cells configured by SN and MN from exceeding the maximum limit (or threshold), MN can optionally adjust the number of conditional reconfigurations triggered by itself, or adjust (reduce) the number of conditional reconfigurations provided by SN, for example, reduce the number of candidate cells. If MN determines to reduce the number of candidate cells provided by SN, provide with SN recommended candidate cells or provide a configurable number of candidate cells by SN. Alternatively, the MN can determine the number of candidate cells that can be configured by the SN or determine the recommended candidate cells based on the measurement result provided by the SN.

FIG. 4 illustrates an interaction among a user equipment, a first node and a second node according to an embodiment.

Referring to FIG. 4, in step 401, the SN sends a message to the MN. The message may be an S-NODE MODIFICATION REQUIRED message, or other messages. The message may also be referred to as the first secondary node modification request. When the SN determines to trigger the Intra-SN S-CPAC, through the message, the SN provides an indication to the MN, and the SN uses the S-CPAC mechanism to change the PSCell, and provides the candidate cell information for the S-CPAC. The message may contain at least one of the following pieces of information:

Identification information of the UE, which includes the identification of the UE on the master base station (M-NG-RAN node UE XnAP ID) and the identification of the UE on the secondary base station (S-NG-RAN node UE XnAP ID).

A configuration format indication, which indicates the information format used when the MN sends the information for S-CPAC to the UE. The configuration format may be an MN configuration format or a SN configuration format. The configuration format is selected by SN. The configuration format indication is an option.

A container from the first secondary node to the master node. The container from the first secondary node to the master node may be a Cell group candidate list (CG-CandidateList) message, which may include one or more of the following pieces of information:

Information of one or more candidate cells (also referred to as first configuration information). The candidate cell is used for S-CPAC. Herein the information of the candidate cell includes at least one of the following pieces of information:

SSB frequency information, that is, ARFCN of SSB of the candidate cell.

A candidate cell identification, which can use PCI or other cell identification. The candidate cell identification may be an identification of a candidate PSCell.

A measurement result, which are included in the SN candidate cell information list (candidateCellInfoListSN), and which include the measurement result of the candidate cell and the measurement results of other cells.

If the MN determines to reduce the number of candidate cells provided by SN, provide with SN recommended candidate cells or provide a configurable number of candidate cells by SN. The MN will determine the number of candidate cells that can be configured by SN or determine the recommended candidate cells based on the measurement result provided by SN. Step 402 will be performed.

The information for S-CPAC provided by SN is obtained through step 403.

Otherwise, step 404 is directly executed.

In step 402, the MN sends a message (also called the first secondary node modification confirmation, or other message names) to the SN. The message may be an S-NODE MODIFICATION CONFIRM message or other messages. The message contains the candidate cell information recommended by MN. The message contains at least one of the following pieces of information:

Information of one or more candidate cells. The candidate cell is used for S-CPAC. Herein the information of the candidate cell includes at least one of the following pieces of information:

SSB frequency information, that is, ARFCN of SSB of the candidate cell.

A candidate cell identification, which can use PCI or other cell identification. The candidate cell identification may be an identification of a candidate PSCell.

A maximum number of PSCells to prepare, indicating the maximum number of candidate cells that SN can configure.

Herein, the information of one or more candidate cells and/or the Maximum Number of PSCells To Prepare included in the first secondary node modification confirmation are determined based on the first configuration information transmitted by MN to SN, so as to ensure that the number of candidate cells configured by the SN for conditional reconfiguration does not exceed the UE capability.

In step 403, the SN sends a message to MN, which may be an S-NODE MODIFICATION REQUIRED message or other messages. The message may also be referred to as a second secondary node modification request. The SN selects candidate cells according to the candidate cells recommended by MN or the Maximum Number of PSCells To Prepare provided by MN, and provides information for S-CPAC. The message may include updated first configuration information and/or second configuration information. For details, please refer to the detailed description of the first configuration information and/or second configuration information in step 301.

Steps 404-406 are the same as steps 302-304, so a detailed description will not be repeated here.

By the method, the number of conditional reconfiguration/the number of candidate cells for conditional reconfiguration are prevented from exceeding the UE capability, which is beneficial to ensuring the reasonable application of conditional reconfiguration, realizing the flexibility of conditional reconfiguration information transmission and improving the cell handover performance.

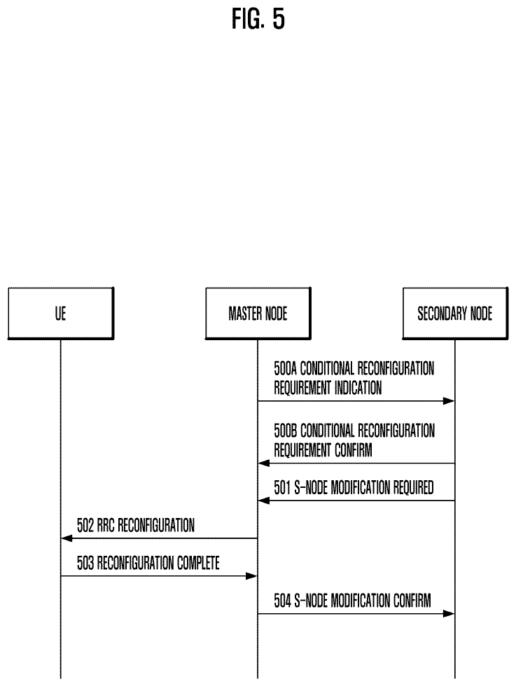

FIG. 5 illustrates an interaction among a user equipment, a first node and a second node according to an embodiment.

Referring to FIG. 5, in step 500A, the MN sends a message to the SN, which contains the maximum number of candidate cells that SN can prepare. The message may be a conditional reconfiguration requirement indication message, or other messages.

The message contains at least one
of a maximum number of PSCells to prepare, indicating the maximum number of candidate cells that the SN can configure.

In step 500B, the SN sends a message to the MN, which is used to send an acknowledgement that the SN has received the information transmitted by the MN. The message may be a conditional reconfiguration requirement confirmation, or other messages.

When the SN determines to trigger Intra-SN S-CPAC, a candidate cell is selected based on the maximum number of PSCells to prepare provided by MN, and sends the information for S-CPAC to MN, and instructs MN to send the information for S-CPAC to UE according to the MN format.

Steps 501-502 are the same as steps 301-302 so the description will not be repeated here.

The UE completes the corresponding configuration according to the received message and sends feedback information to the MN.

Steps 503-504 are the same as steps 303-304 so the description will not be repeated here.

By the method, the number of conditional reconfiguration/the number of candidate cells for conditional reconfiguration are prevented from exceeding the UE capability, which is beneficial to ensuring the reasonable application of conditional reconfiguration, realizing the flexibility of conditional reconfiguration information transmission and improving the cell handover performance.

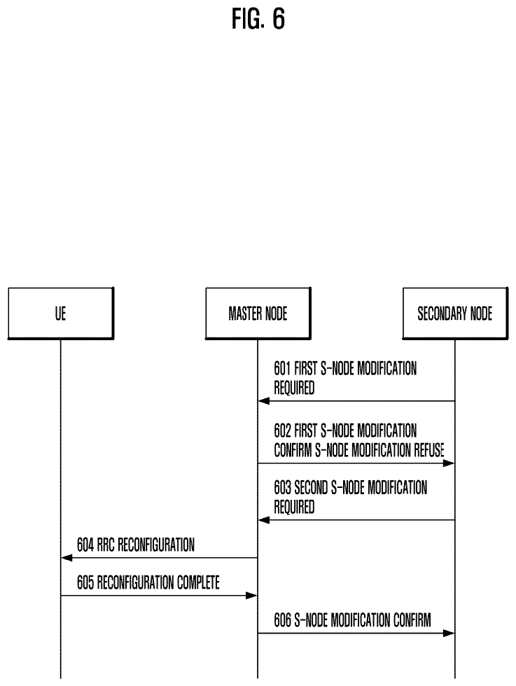

FIG. 6 illustrates an interaction among a user equipment, a first node and a second node according to an embodiment. Referring to FIG. 6, the SN sends information to the MN to instruct the SN to change the PSCell by using the S-CPAC mechanism. After obtaining the confirmation from the MN, the SN provides information for the S-CPAC.

In step 601, the SN sends a message to the MN. The message may be an S-NODE MODIFICATION REQUIRED message, or other messages. The message may also be referred to as the first secondary node modification request. When SN determines to trigger Intra-SN S-CPAC, the SN provides an indication to the MN through the message, and SN adopts S-CPAC mechanism to change PSCell and provides information for initial S-CPAC. The message contains at least one of the following pieces of information:

An identification information of the UE, which includes the identification of the UE on the master base station (M-NG-RAN node UE XnAP ID) and the identification of the UE on the secondary base station (S-NG-RAN node UE XnAP ID).

A configuration format indication, indicating the configuration format adopted by S-CPAC configuration. The configuration format may be an MN configuration format or a SN configuration format. If the configuration format indication is included, it can also be used to indicate to MN that SN will change PSCell in S-CPAC mode.

A container from the second secondary node to the master node. The container from the second secondary node to the master node may be a CG-Config message, which is SCG radio configuration information provided by SN, and contains execution condition information and/or configuration related information of one or more candidate cells. The candidate cell, the execution condition, and the configuration are used for S-CPAC. The configuration information includes at least one of the following pieces of information:

Execution condition information of one or more candidate cells, which contains at least one of the following pieces of information:

A candidate cell identification of the first candidate cell, PSCell, which can be PCI or other cell identifications.

Execution condition information (also referred to as first execution condition information), that is, the execution condition associated with the candidate cell. When the candidate cell meets the execution conditions, the UE can select the candidate cell as the target cell. The execution condition information is configured by the source cell (PSCell) (or SN) and is used for the initial S-CPAC process, that is, the execution condition/execution condition information for the initial S-CPAC. The execution condition information can be identified by using the execution condition of SCG condition (condExecutionCondSCG).

A Cell group configuration, which can also be referred to as the cell group configuration of the SCG-CellGroupConfig, contains the cell group configuration information of the SCG of the source PSCell and contains the measurement configuration (MeasConfig) related to the execution condition, which can also be referred to as measurement configuration information. The measurement configuration is a measurement configuration provided by a source PSCell (or SN).

A measurement result, which are included in the SN candidate cell information list (candidateCellInfoListSN), and which include the measurement result of the candidate cell and the measurement results of other cells.

In step 602, the MN sends a message to the SN.

When the MN receives the indication that the SN will change the PSCell in the S-CPAC mode in step 601, if the MN accepts it, the MN will send a message to indicate acceptance. The message may include the number of candidate cells that the SN is suggested to configure. The message may be an S-NODE MODIFICATION CONFIRM message, or may be referred to as a first secondary node modification confirmation, or other messages. The message contains at least one of the following pieces of information:

Identification information of the UE, which includes the identification of the UE on the master base station (M-NG-RAN node UE XnAP ID) and the identification of the UE on the secondary base station (S-NG-RAN node UE XnAP ID),
and a maximum number of candidate cells, indicating the maximum number of candidate cells that the SN can configure.

If the MN refuses, a message will be sent to indicate. The message may be an S-NODE MODIFICATION REFUSE message, a first secondary node modification refuse, or other messages.

In step 603, the SN sends a message to the MN, which may be an S-NODE MODIFICATION REQUIRED message or other messages. The message may also be referred to as a second secondary node modification request and provide information for following S-CPAC. The message contains at least one of the following pieces of information:

Identification information of the UE, which includes the identification of the UE on the master base station (M-NG-RAN node UE XnAP ID) and the identification of the UE on the secondary base station (S-NG-RAN node UE XnAP ID).

A container from the first secondary node to the master node. The container from the first secondary node to the master node may be a Cell group candidate list (CG-CandidateList) message and contains the configuration information of one or more candidate cells (that is, SCG radio configuration information of candidate cells). The candidate cells and the configuration information are used for S-CPAC. The configuration information of the candidate cell includes at least one of the following pieces of information:

SSB frequency information, that is, ARFCN of SSB of the candidate cell.

A candidate cell identification, that is, the identification of the candidate PSCell, which can be PCI or other cell identifications.

A Cell group configuration, which can also be referred to as cell group configuration information. The cell group configuration, that is, the cell group configuration of SCG-CellGroupConfig, is the cell group configuration of SCG of the PSCell. The cell group configuration of the SCG of the candidate cell can also be referred to as cell group configuration information of the SCG of the candidate cell, or cell group configuration of the candidate cell, or cell group configuration information of the candidate cell, and contains the SCG information or configuration information of the candidate cell.

An SCG (secondaryCellGroup), or a second cell group, which contains the cell group configuration (CellGroupConfig). The SCG is the cell group configuration or cell group configuration information of the PSCell.

Measurement configuration (measConfig) information. The measurement configuration is provided by a PSCell (or SN).

A candidate cell information list, that is, a candidate cell information list for the following S-CPAC process (candidateCellInfoListSubsequentCPC). The candidate cell is used in the following S-CPAC process. The candidate cell information includes at least one of the following pieces of information:

The candidate cell identification, that is, the identification of the candidate PSCell, which can be PCI or other cell identifications.

Execution condition information associated to the candidate cell and used for execution of the following S-CPAC process.

The cell group configuration and the candidate cell information list can be contained in one information element which may be a CG-Config IE.

Steps 604-406 are the same as steps 302-304, so a detailed description will not be repeated here.

By the method, the flexibility of conditional reconfiguration information transmission can be realized, and the cell handover performance can be improved.

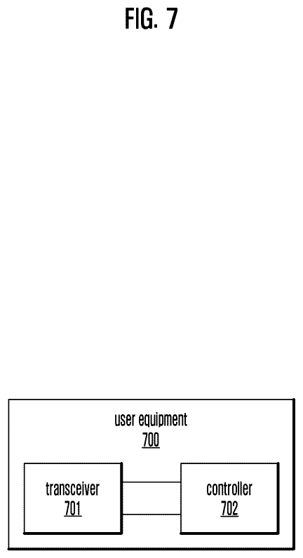

FIG. 7 illustrates the structure of a user equipment 700 according to an embodiment.

Referring to FIG. 7, a user equipment 700 includes a transceiver 701 and a controller 702. The transceiver 701 is configured to transmit and receive signals to and from the outside. The controller 702 is configured to perform the above-described method performed by the user equipment. The user equipment 700 may be implemented in the form of hardware, software, or a combination of hardware and software, so that it can perform the method performed by the user equipment described in the present disclosure.

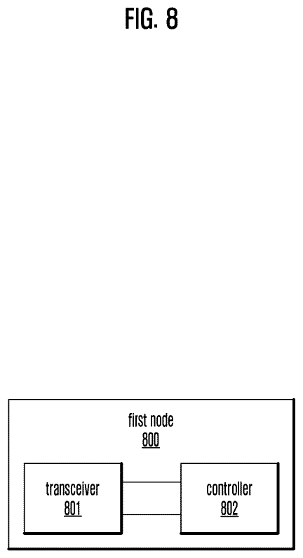

FIG. 8 illustrates the structure of a first node 800 according to an embodiment.

Referring to FIG. 8, a first node 800 includes a transceiver 801 and a controller 802. The transceiver 801 is configured to transmit and receive signals to and from the outside. The controller 802 is configured to perform a method performed by a first node. The first node 800 may be implemented in the form of hardware, software, or a combination of hardware and software, so that it can perform the method described in the present disclosure and performed by the first node.

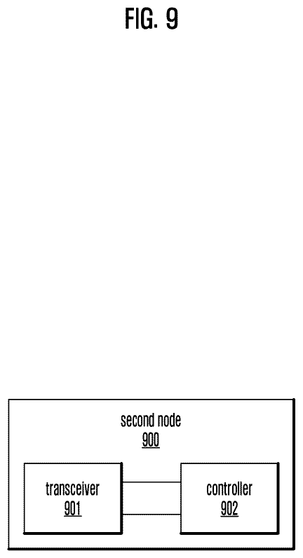

FIG. 9 illustrates the structure of a second node 900 according to an embodiment.

Referring to FIG. 9, the second node 900 includes a transceiver 901 and a controller 902. The transceiver 901 is configured to transmit and receive signals to and from the outside.

The controller 902 is configured to perform a method performed by the second node. The second node 900 may be implemented in the form of hardware, software, or a combination of hardware and software, so that it can perform the method performed by the second node described in the present disclosure.

At least one embodiment of the present disclosure also provides a non-transitory computer-readable recording medium, on which a program for executing the above method when a computer is in operation has been stored.

Various embodiments of the present disclosure can be realized as computer-readable codes embodied on a computer-readable recording medium from a specific perspective. A computer-readable recording medium is any data storage device that can store data readable by a computer system. Examples of computer-readable recording media may include read-only memory (ROM), random access memory (RAM), compact disk read-only memory (CD-ROM), magnetic tape, floppy disk, optical data storage device, carrier wave (for example, data transmission via the Internet), and the like. Computer-readable recording media can be distributed through computer systems connected via a network, and thus computer-readable codes can be stored and executed in a distributed manner. Moreover, functional programs, codes and code segments for implementing embodiments of the disclosure can be easily interpreted by those skilled in the art to which the embodiments are applied.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method performed by a master node (MN) in a communication system, the method comprising:
receiving, from a secondary node (SN), an SN modification required message including information indicating that a modification of an SN configuration is for an intra-SN subsequent—conditional primary/secondary cell (PSCell) addition/change (S-CPAC) in an MN format and configuration information on an execution condition for the intra-SN S-CPAC;
transmitting, to the SN, a request message for the modification of the SN configuration, based on the information; and
receiving, from the SN, a response message including additional configuration information on the execution condition for the intra-SN S-CPAC.

2. The method of claim 1,
wherein the configuration information includes first information on an execution condition for an initial execution of the intra-SN S-CPAC or second information on an execution condition for a following execution of the intra-SN S-CPAC.

3. The method of claim 2,
wherein in case that the configuration information includes the first information, and the additional configuration information includes the second information,
wherein the first information is included in a cell group configuration (CG-Config) message, and
wherein the second information is included in a cell group candidate list (CG-CandidateList) message.

4. The method of claim 3, further comprising:
transmitting, to a terminal, a radio resource control (RRC) message including the first information and the second information.

5. The method of claim 1,
wherein the SN modification required message further includes information on candidate cells for the intra-SN S-CPAC in the MN format,
wherein the execution condition is associated with the candidate cells, and
wherein the request message further includes an identification (ID) of a terminal for the MN, an ID of the terminal for the SN, and information on a maximum number of the candidate cells.

6. A method performed by a secondary node (SN) in a communication system, the method comprising:
transmitting, to a master node (MN), an SN modification required message including information indicating that a modification of an SN configuration is for an intra-SN subsequent—conditional primary/secondary cell (PSCell) addition/change (S-CPAC) in an MN format and configuration information on an execution condition for the intra-SN S-CPAC;
receiving, from the MN, a request message for the modification of the SN configuration, based on the information; and
transmitting, to the MN, a response message including additional configuration information on the execution condition for the intra-SN S-CPAC.

7. The method of claim 6,
wherein the configuration information includes first information on an execution condition for an initial execution of the intra-SN S-CPAC or second information on an execution condition for a following execution of the intra-SN S-CPAC.

8. The method of claim 7,
wherein in case that the configuration information includes the first information, and the additional configuration information includes the second information,
wherein the first information is included in a cell group configuration (CG-Config) message, and
wherein the second information is included in a cell group candidate list (CG-CandidateList) message.

9. The method of claim 8,
wherein the first information and the second information are transmitted to the terminal via a radio resource control (RRC) message.

10. The method of claim 6,
wherein the SN modification required message further includes information on candidate cells for the intra-SN S-CPAC in the MN format,
wherein the execution condition is associated with the candidate cells, and
wherein the request message further includes an identification (ID) of a terminal for the MN, an ID of the terminal for the SN, and information on a maximum number of the candidate cells.

11. A master node (MN) in a communication system, the MN comprising:
a transceiver; and
a processor coupled with the transceiver and configured to:
receive, from a secondary node (SN), an SN modification required message including information indicating that a modification of an SN configuration is for an intra-SN subsequent—conditional primary/secondary cell (PSCell) addition/change (S-CPAC) in an MN format and configuration information on an execution condition for the intra-SN S-CPAC,
transmit, to the SN, a request message for the modification of the SN configuration, based on the information, and
receive, from the SN, a response message including additional configuration information on the execution condition for the intra-SN S-CPAC.

12. The MN of claim 11,
wherein the configuration information includes first information on an execution condition for an initial execution of the intra-SN S-CPAC or second information on an execution condition for a following execution of the intra-SN S-CPAC.

13. The MN of claim 12,
wherein in case that the configuration information includes the first information, and the additional configuration information includes the second information,
wherein the first information is included in a cell group configuration (CG-Config) message, and
wherein the second information is included in a cell group candidate list (CG-CandidateList) message.

14. The MN of claim 13,
wherein the processor is further configure to transmit, to a terminal, a radio resource control (RRC) message including the first information and the second information.

15. The MN of claim 11,
wherein the SN modification required message further includes information on candidate cells for the intra-SN S-CPAC in the MN format,
wherein the execution condition is associated with the candidate cells, and
wherein the request message further includes an identification (ID) of a terminal for the MN, an ID of the terminal for the SN, and information on a maximum number of the candidate cells.

16. A secondary node (SN) in a communication system, the SN comprising:
a transceiver; and
a processor coupled with the transceiver and configured to:
transmit, to a master node (MN), an SN modification required message including information indicating that a modification of an SN configuration is for an intra-SN subsequent-conditional primary/secondary cell (PSCell) addition/change (S-CPAC) in an MN format and configuration information on an execution condition for the intra-SN S-CPAC,
receive, from the MN, a request message for the modification of the SN configuration, based on the information, and
transmit, to the MN, a response message including additional configuration information on the execution condition for the intra-SN S-CPAC.

17. The SN of claim 16,
wherein the configuration information includes first information on an execution condition for an initial execution of the intra-SN S-CPAC or second information on an execution condition for a following execution of the intra-SN S-CPAC.

18. The SN of claim 17,
wherein in case that the configuration information includes the first information, the additional configuration information includes the second information,
wherein the first information is included in a cell group configuration (CG-Config) message, and
wherein the second information is included in a cell group candidate list (CG-CandidateList) message.

19. The SN of claim 18,
wherein the first information and the second information are transmitted to the terminal via a radio resource control (RRC) message.

20. The SN of claim 16,
wherein the SN modification required message further includes information on candidate cells for the intra-SN S-CPAC in the MN format,
wherein the execution condition is associated with the candidate cells, and
wherein the request message further includes an identification (ID) of a terminal for the MN, an ID of the terminal for the SN, and information on a maximum number of the candidate cells.
